(19) United States
(12) Patent Application Publication
(10) Pub. No.: US 2025/0030443 A1
(43) Pub. Date: Jan. 23, 2025

(54) WIRELESS COMMUNICATION DEVICES AND RELATED METHODS

(71) Applicant: PLUME DESIGN, INC., Palo Alto, CA (US)

(72) Inventors: Ming-Tsung SU, Taipei City (TW); Miroslav SAMARDZIJA, Mountain View, CA (US); Arthur TUNG, San Jose, CA (US); Yun Ping HUANG, Santa Clara, CA (US)

(21) Appl. No.: 18/355,631

(22) Filed: Jul. 20, 2023

(51) Int. Cl. H04B 1/036; H01Q 1/02; H01Q 1/52

(52) U.S. Cl. CPC H04B 1/036; H01Q 1/02; H01Q 1/526

(57) ABSTRACT

A wireless communication device may include a wireless communication element configured to at least one of transmit or receive a wireless signal. The device may include a heat sink configured to draw heat away from the wireless communication element. The device may include at least one airflow port positioned to allow air to flow across the heat sink. The device may include a conductive shield at least partially covering the at last one airflow port, the conductive shield including a plurality of apertures positioned over the at least one airflow port and configured to allow the air to flow through the at least one airflow port, wherein the conductive shield is configured to inhibit passage of electromagnetic noise through the at least one airflow port. Various other related systems and methods are also disclosed.

### BRIEF DESCRIPTION OF THE DRAWINGS

FIG. 1 is an exploded view of a wireless communication device, according to at least one embodiment of the present disclosure.

FIG. 2 is a perspective view of the wireless communication device of FIG. 1 and including a conductive shield for covering airflow ports of the wireless communication device, according to at least one embodiment of the present disclosure.

FIG. 3 is a perspective view of the wireless communication device including the conductive shield for covering airflow ports connected to the body of the wireless communication device, according to at least one embodiment of the present disclosure.

FIG. 4 is a perspective view of a wireless communication device with a top cover removed and illustrating airflow across internal components of the wireless communication device, according to at least one embodiment of the present disclosure.

FIG. 5 is a flow diagram illustrating a method of fabricating a wireless communication element, according to at least one embodiment of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION

Wireless communication devices, such as wireless signal extenders, may include elements that receive and/or transmit wireless signals. Such elements may be susceptible to receiving electromagnetic noise, such as stray signals or signals from other electronic devices. Such noise may cause the wireless communication devices to receive, process, and/or transmit unintended data.

Additionally, the electronic components of wireless communication devices may generate heat during operation. If this heat is not reduced by external or internal cooling, the heat can reach a level that may cause damage to one or more of the electronic components in the wireless communication devices. Cooling systems can include airflow ports, fans, and the like, to allow or force air to flow across the electronic components to withdraw heat. In some examples, a heat sink may be used to withdraw heat from the electronic components. A heat sink may be used in conjunction with forced air and/or ambient air.

The present disclosure provides detailed descriptions of wireless communication devices. As will be explained in greater detail below, embodiments of the present disclosure may include wireless communication devices (e.g., wireless signal extenders) that may include a wireless communication element, a heat sink, at least one airflow port, and a conductive shield. The wireless communication element may be configured to transmit and/or receive a wireless signal. The heat sink may be configured to draw heat away from the wireless communication element. The airflow port(s) may be positioned to allow air to flow across the heat sink, such as in response to a fan being operated. The conductive shield may at least partially cover the airflow port(s). A plurality of apertures through the conductive shield may be positioned over the airflow port(s) to allow the air to flow through the airflow port(s). The conductive shield may also be configured to inhibit (e.g., reduce, block, etc.) the passage of electromagnetic noise through the airflow port(s).

Features from any of the embodiments described herein may be used in combination with one another in accordance with the general principles described herein. These and other embodiments, features, and advantages will be more fully understood upon reading the following detailed description in conjunction with the accompanying drawings and claims.

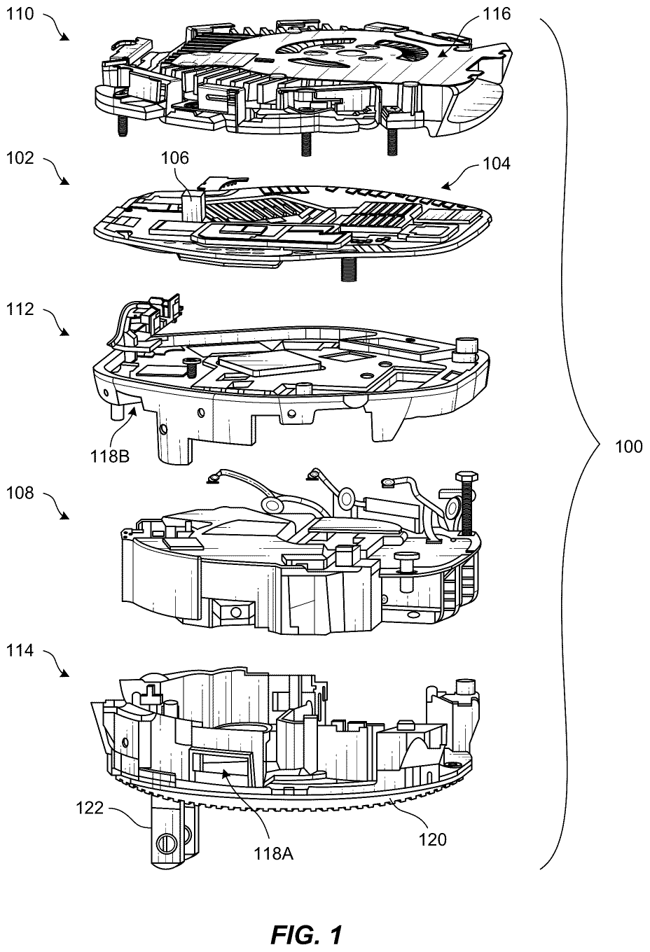

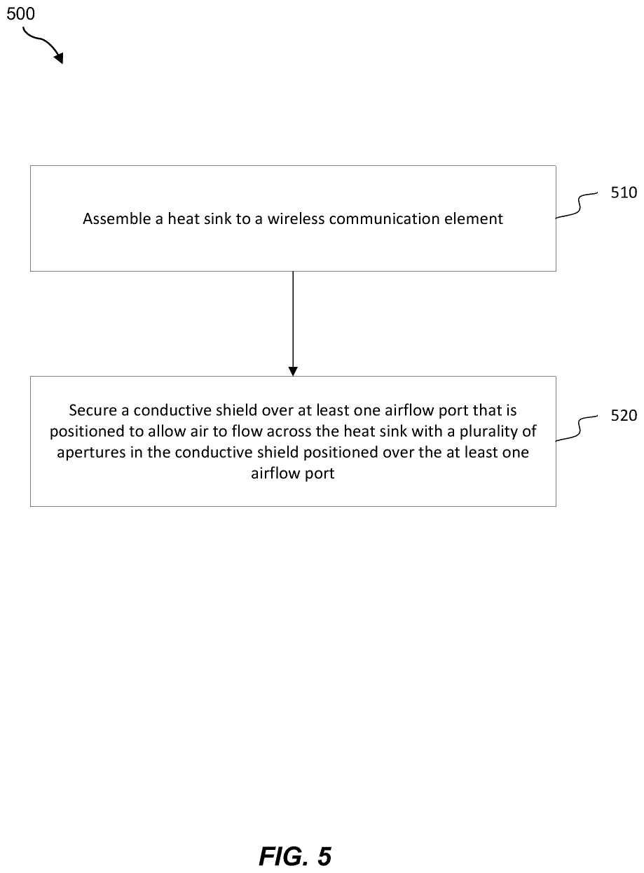

The following will provide, with reference to FIGS. 1-4, detailed descriptions of wireless communications devices and components thereof. With reference to FIG. 5, the following will provide detailed descriptions of a method for fabricating wireless communications devices.

FIG. 1 is an exploded view of a wireless communication device 100, according to at least one embodiment of the present disclosure. The wireless communication device 100 may include a first printed circuit board 102 supporting functional components 104, such as a wireless communication element 106 (e.g., a transceiver, a wireless signal extender element, etc.) configured to transmit and/or receive a wireless (e.g., radio-frequency) signal. The wireless communication device 100 may also include a second printed circuit board 108, which may be a power printed circuit board with electrical power supply components configured to provide power to the wireless communication element 106.

The wireless communication device 100 may also include a heat sink, which may include a first heat spreader 110, a second heat spreader 112, and a third heat spreader 114. The first heat spreader 110 may be positioned adjacent to the first printed circuit board 102 on a side of the first printed circuit board 102 opposite the second printed circuit board 108. The second heat spreader 112 may be positioned between the first printed circuit board 102 and the second printed circuit board 108. The third heat spreader 114 may be positioned adjacent to the second printed circuit board 108 on a side of the second printed circuit board 108 opposite the first printed circuit board 102.

The heat sink, including the first, second, and third heat spreaders 110, 112, 114, may be configured to draw heat away from the wireless communication element 106, the other functional components 104, and/or the power supply components of the second printed circuit board 108. For example, the heat sink may include heat dissipation features (e.g., fins, bulk material elements, etc.) formed of thermally conductive material, such as a metal material. The first heat spreader 110 may also support a fan 116 that may be configured to force air across the heat sink.

At least one airflow port may be positioned to allow air to flow across the heat sink (e.g., across at least one of the first heat spreader 110, second heat spreader 112, and/or third heat spreader 114). For example, a first airflow port 118A may be an air inlet port and a second airflow port 118B may be an air outlet port. The first airflow port 118A and second airflow port 118B are also referred to collectively as airflow ports 118.

As illustrated in FIG. 1, the third heat spreader 114 may be secured to, or may be a part of, a base housing cover 120. The base housing cover 120 may include an electrical plug 122 for engaging and drawing power from an electrical outlet. When the wireless communication device 100 is assembled, the electrical plug 122 may be operably coupled to the second printed circuit board 108 for providing power to the wireless communication device 100.

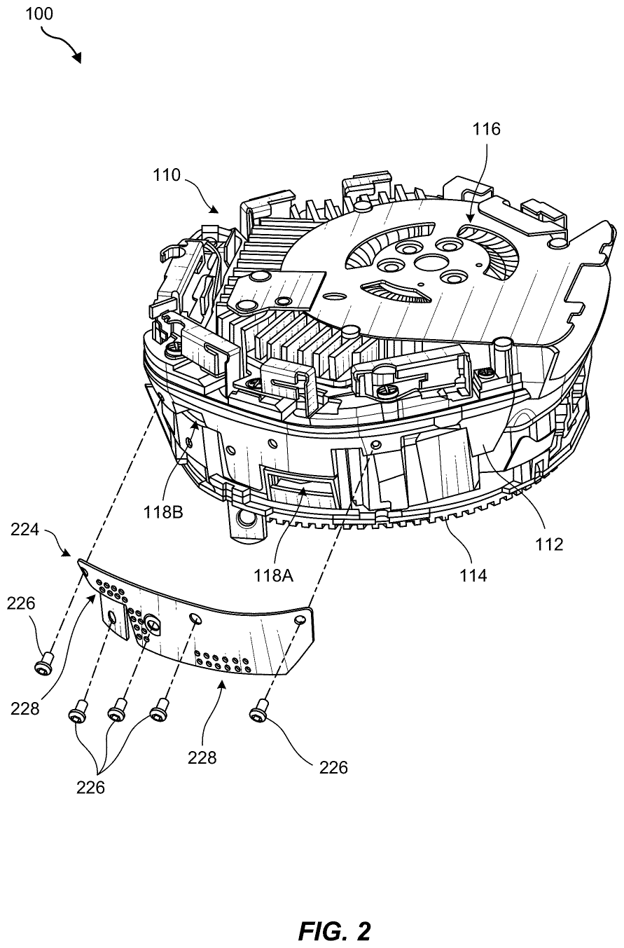

FIG. 2 is a perspective view of the wireless communication device 100 of FIG. 1 and including a conductive shield 224 for covering the first airflow port 118A and second airflow port 118B, according to at least one embodiment of the present disclosure. The conductive shield 224 is shown in FIG. 2 disconnected from a body of the wireless communication device 100.

The conductive shield 224 may be coupled to the body of the wireless communication device 100 by bolts 226 (e.g., conductive bolts, such as metallic bolts). For example, the bolts 226 may secure the conductive shield 224 to the second heat spreader 112 and to the third heat spreader 114. The bolts 226 and the abutment of the conductive shield 224 against the second and third heat spreaders 112, 114 may ground-link the conductive shield 224 to the second and third heat spreaders 112, 114, physically and electrically connecting the conductive shield 224 to the second and third heat spreaders 112, 114. The conductive shield 224 may also improve and/or supplement a ground connection between the second heat spreader 112 and the third heat spreader 114. The conductive shield 224 may further act as a heat sink, absorbing and dissipating heat from air passing across the conductive shield 224.

The conductive shield 224 may include a plurality of apertures 228, which may be arranged in one or more arrays, for allowing air to flow through the first airflow port 118A and/or second airflow port 118B underlying the conductive shield 224. For example, a first array of apertures 228 may be positioned over the first airflow port 118A and a second array of apertures 228 may be positioned over the second airflow port 118B.

The conductive shield 224 may be configured to inhibit the passage of electromagnetic noise through the first airflow port 118A and/or second airflow port 118B, which may improve performance of the wireless communication element 106 while still allowing for sufficient airflow and, consequently, cooling of the wireless communication device 100.

The conductive shield 224 may be formed of a unitary, integral piece of conductive material, such as a piece of sheet metal (e.g., stainless steel, aluminum, etc.) that is stamped, cut, bent, drilled, and/or otherwise formed into its final shape and size for connection to the wireless communication device 100.

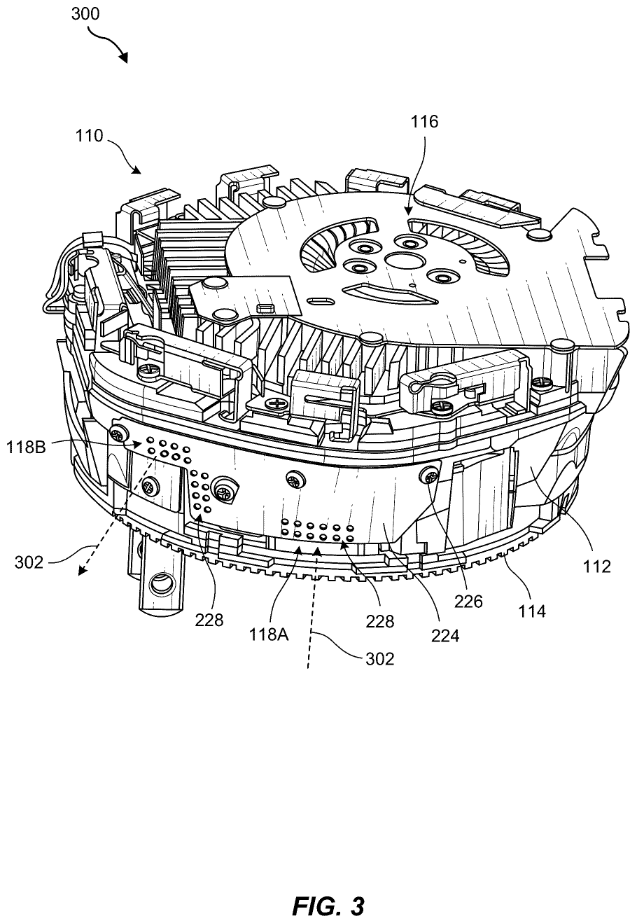

FIG. 3 is a perspective view of the wireless communication device 100 including the conductive shield 224 for covering airflow ports 118 connected to the body of the wireless communication device 100, according to at least one embodiment of the present disclosure.

As illustrated in FIG. 3, the conductive shield 224 may be secured to the second heat spreader 112 and to the third heat spreader 114 via the bolts 226. The apertures 228 of the conductive shield 224 may be positioned over the airflow ports 118 to allow cooling air to flow through the airflow ports 118. For example, upon operation of the fan 116, air 302 may flow into the first airflow port 118A, across internal components (e.g., at least the second heat spreader 112 and the third heat spreader 114) of the wireless communication device 100, and out through the second airflow port 118B.

The apertures 228 may be configured to allow a sufficient amount of the air 302 to flow through the wireless communication device 100 while also shielding electrical noise from passing through the airflow ports 118. For example, an array of apertures 228 may be positioned over each of the airflow ports 118. The arrays may include one or more rows of apertures 228 and one or more columns of apertures 228. The number of rows and columns of apertures 228 in each array may, at least in part, depend on the size and shape of the underlying airflow port 118. The size and shape of each aperture 228 may also be configured to inhibit (e.g., reduce or block) the passage of electromagnetic noise across the conductive shield 224.

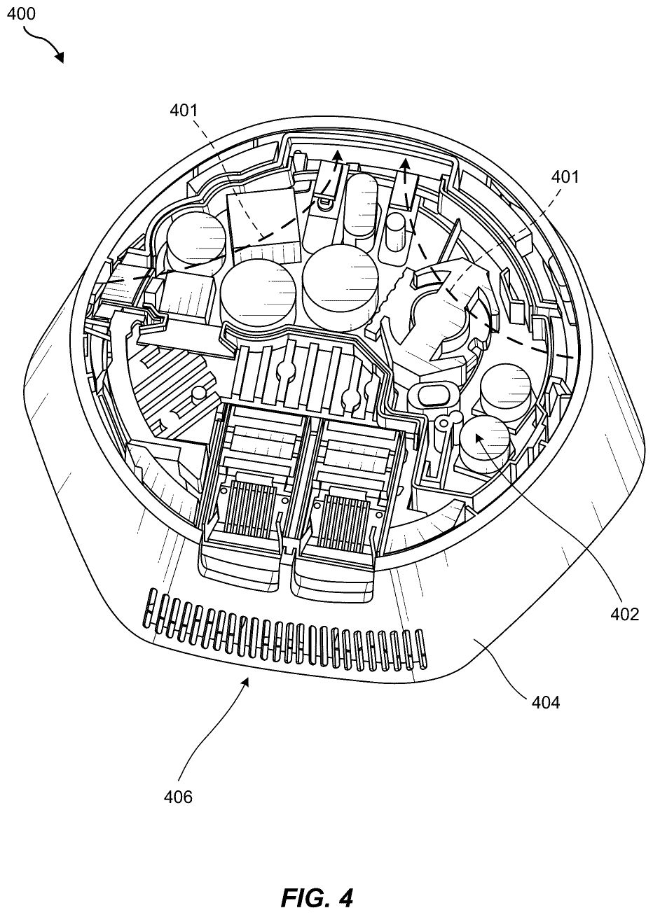

FIG. 4 is a perspective view of a wireless communication device 400 with a top cover removed and illustrating airflow 401 across internal components of the wireless communication device 400, according to at least one embodiment of the present disclosure.

In some respects, the wireless communication device 400 of FIG. 4 may be similar to the wireless communication device 100 discussed above with reference to FIGS. 1-3. For example, the wireless communication device 400 may include internal components 402, such as a printed circuit board supporting power supply components, a printed circuit board supporting wireless communication elements (e.g., a wireless signal extender element), a heat sink, and a conductive shield covering airflow ports (e.g., the conductive shield 224 discussed above). The heat sink may include one or more heat spreaders. The wireless communication device 400 may also include a fan used to force air 401 through the wireless communication device 400 and across at least some of the internal components 402 for cooling.

As illustrated in FIG. 4, the wireless communication device 400 may include an outer housing 402, which may be used to physically protect the internal components 402, such as from dust, moisture, damage, and the like. The outer housing 402 may include a polymer material. A vent 404 in the outer housing 402 may allow the air 401 to flow into an area around the internal components 402 when the fan within the wireless communication device 400 is operated. The air 401 may flow through apertures in a conductive shield (e.g., conductive shield 224 described above) and through an airflow port (e.g., airflow ports 118 described above) to reach and cool the internal components 402.

FIG. 5 is a flow diagram illustrating a method 500 of fabricating a wireless communication element, according to at least one embodiment of the present disclosure.

At operation 510, a heat sink may be assembled to a wireless communication element. The wireless communication element (e.g., a wireless signal extender element) may be configured to at least one of transmit or receive a wireless signal. The heat sink may be configured to draw heat away from the wireless communication element, as well as from other internal components of the wireless communication element. Operation 510 may be performed in a variety of ways. For example, assembling the heat sink to the wireless communication element may include assembling a first heat spreader to one side of the wireless communication element and assembling a second heat spreader to an opposing side of the wireless communication element.

At operation 520, a conductive shield may be secured over at least one airflow port that is positioned to allow air to flow across the heat sink. The conductive shield may include a plurality of apertures that may be positioned over the at least one airflow port. The conductive shield may be configured to inhibit passage of electromagnetic noise through the at least one airflow port. Operation 520 may be performed in a variety of ways. For example, the conductive shield may be secured over the at least one airflow port by bolting the conductive shield to the heat sink, such as to a first heat spreader of the heat sink and to a second heat spreader of the heat sink.

Accordingly, the present disclosure includes wireless communication devices and related methods that may exhibit improved operational parameters, such as reduced noise while still providing sufficient cooling for proper functioning. The wireless communication devices may include a conductive shield covering one or more airflow ports. The conductive shield may include apertures positioned over the airflow ports, which may allow for air to flow through the airflow ports.

The following example embodiments are also included in the present disclosure.

Example 1: A wireless communication device, including: a wireless communication element configured to at least one of transmit or receive a wireless signal; a heat sink configured to draw heat away from the wireless communication element; at least one airflow port positioned to allow air to flow across the heat sink; and a conductive shield at least partially covering the at last one airflow port, the conductive shield including a plurality of apertures positioned over the at least one airflow port and configured to allow the air to flow through the at least one airflow port, wherein the conductive shield is configured to inhibit passage of electromagnetic noise through the at least one airflow port.

Example 2. The wireless communication device of Example 1, wherein the wireless communication element includes a wireless signal extender element.

Example 3. The wireless communication device of Example 1 or Example 2, wherein the heat sink includes a first heat spreader and a second heat spreader assembled with the first heat spreader.

Example 4. The wireless communication device of Example 3, wherein the conductive shield is physically and electrically connected to the first heat spreader and to the second heat spreader.

Example 5. The wireless communication device of any of Examples 1 through 4, wherein the plurality of apertures includes an array of apertures over each airflow port of the at least one airflow port.

Example 6. The wireless communication device of any of Examples 1 through 5, wherein the at least one airflow port includes an air inlet port.

Example 7. The wireless communication device of any of Examples 1 through 6, wherein the at least one airflow port includes an air outlet port.

Example 8. The wireless communication device of any of Examples 1 through 7, wherein the at least one airflow port includes an air inlet port and an air outlet port, wherein the plurality of apertures includes a first array of apertures over the air inlet port and a second array of apertures over the air outlet port.

Example 9. The wireless communication device of any of Examples 1through 8, wherein the conductive shield includes a metal plate material.

Example 10. The wireless communication device of Example 9, wherein the metal plate material includes a stainless-steel plate material.

Example 11. The wireless communication device of any of Examples 1 through 10, further including conductive bolts securing the conductive shield to the heat sink.

Example 12. A wireless communication device, including: a transceiver configured to receive and transmit a wireless signal, the transceiver positioned on a first printed circuit board; a second printed circuit board configured to provide power to the transceiver; a first heat spreader positioned adjacent to the first printed circuit board on a side of the first printed circuit board opposite the second printed circuit board; a second heat spreader positioned between first printed circuit board and the second printed circuit board; a third heat spreader positioned adjacent to the second printed circuit board on a side of the second printed circuit board opposite the first printed circuit board; an airflow port positioned to allow air to flow across at least one of the first heat spreader, second heat spreader, or third heat spreader; and a conductive shield including a plurality of apertures positioned over the airflow port to allow the air to flow the at least one airflow port.

Example 13. The wireless communication device of Example 12, wherein the transceiver includes a radio-frequency transceiver.

Example 14. The wireless communication device of Example 12 or Example 13, wherein the conductive shield is configured to inhibit passage of electromagnetic noise through the at least one airflow port.

Example 15. The wireless communication device of any of Examples 12 through 14, wherein the conductive shield includes a metal plate material.

Example 16. The wireless communication device of any of Examples 12 through 15, wherein the conductive shield is secured to at least one of the first heat spreader, second heat spreader, or third heat spreader.

Example 17. The wireless communication device of any of Examples 12 through 16, further including a fan configured to force the air through the airflow port.

Example 18. A method of fabricating a wireless communication device, the method including: assembling a heat sink to a wireless communication element configured to at least one of transmit or receive a wireless signal, the heat sink configured to draw heat away from the wireless communication element; and securing a conductive shield over at least one airflow port that is positioned to allow air to flow across the heat sink with a plurality of apertures in the conductive shield positioned over the at least one airflow port, wherein the conductive shield is configured to inhibit passage of electromagnetic noise through the at least one airflow port.

Example 19. The method of Example 18, wherein securing the conductive shield over the at least one airport includes bolting the conductive shield to the heat sink.

Example 20. The method of Example 18 or Example 19, wherein assembling the heat sink to the wireless communication element includes assembling a first heat spreader to one side of the wireless communication element and assembling a second heat spreader to an opposing side of the wireless communication element.

In some examples, relational terms, such as “first,” “second,” etc., may be used for clarity and convenience in understanding the disclosure and accompanying drawings and do not connote or depend on any specific preference, orientation, or order, except where the context clearly indicates otherwise.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered example in nature since many other architectures can be implemented to achieve the same functionality.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A wireless communication device, comprising:
a wireless communication element configured to at least one of transmit or receive a wireless signal;
a heat sink configured to draw heat away from the wireless communication element;
at least one airflow port positioned to allow air to flow across the heat sink; and
a conductive shield at least partially covering the at last one airflow port, the conductive shield comprising a plurality of apertures positioned over the at least one airflow port and configured to allow the air to flow through the at least one airflow port, wherein the conductive shield is configured to inhibit passage of electromagnetic noise through the at least one airflow port.

2. The wireless communication device of claim 1, wherein the wireless communication element comprises a wireless signal extender element.

3. The wireless communication device of claim 1, wherein the heat sink comprises a first heat spreader and a second heat spreader assembled with the first heat spreader.

4. The wireless communication device of claim 3, wherein the conductive shield is physically and electrically connected to the first heat spreader and to the second heat spreader.

5. The wireless communication device of claim 1, wherein the plurality of apertures comprises an array of apertures over each airflow port of the at least one airflow port.

6. The wireless communication device of claim 1, wherein the at least one airflow port comprises an air inlet port.

7. The wireless communication device of claim 1, wherein the at least one airflow port comprises an air outlet port.

8. The wireless communication device of claim 1, wherein the at least one airflow port comprises an air inlet port and an air outlet port, wherein the plurality of apertures comprises a first array of apertures over the air inlet port and a second array of apertures over the air outlet port.

9. The wireless communication device of claim 1, wherein the conductive shield comprises a metal plate material.

10. The wireless communication device of claim 9, wherein the metal plate material comprises a stainless-steel plate material.

11. The wireless communication device of claim 1, further comprising conductive bolts securing the conductive shield to the heat sink.

12. A wireless communication device, comprising:
a transceiver configured to receive and transmit a wireless signal, the transceiver positioned on a first printed circuit board;
a second printed circuit board configured to provide power to the transceiver;
a first heat spreader positioned adjacent to the first printed circuit board on a side of the first printed circuit board opposite the second printed circuit board;
a second heat spreader positioned between first printed circuit board and the second printed circuit board;
a third heat spreader positioned adjacent to the second printed circuit board on a side of the second printed circuit board opposite the first printed circuit board;
an airflow port positioned to allow air to flow across at least one of the first heat spreader, second heat spreader, or third heat spreader; and
a conductive shield comprising a plurality of apertures positioned over the airflow port to allow the air to flow the at least one airflow port.

13. The wireless communication device of claim 12, wherein the transceiver comprises a radio-frequency transceiver.

14. The wireless communication device of claim 12, wherein the conductive shield is configured to inhibit passage of electromagnetic noise through the at least one airflow port.

15. The wireless communication device of claim 12, wherein the conductive shield comprises a metal plate material.

16. The wireless communication device of claim 12, wherein the conductive shield is secured to at least one of the first heat spreader, second heat spreader, or third heat spreader.

17. The wireless communication device of claim 12, further comprising a fan configured to force the air through the airflow port.

18. A method of fabricating a wireless communication device, the method comprising:
assembling a heat sink to a wireless communication element configured to at least one of transmit or receive a wireless signal, the heat sink configured to draw heat away from the wireless communication element; and
securing a conductive shield over at least one airflow port that is positioned to allow air to flow across the heat sink with a plurality of apertures in the conductive shield positioned over the at least one airflow port, wherein the conductive shield is configured to inhibit passage of electromagnetic noise through the at least one airflow port.

19. The method of claim 18, wherein securing the conductive shield over the at least one airport comprises bolting the conductive shield to the heat sink.

20. The method of claim 18, wherein assembling the heat sink to the wireless communication element comprises assembling a first heat spreader to one side of the wireless communication element and assembling a second heat spreader to an opposing side of the wireless communication element.
